(19) United States
(12) Patent Application Publication
(10) Pub. No.: US 2003/0005317 A1
(43) Pub. Date: Jan. 2, 2003

(54) Method and system for generating and verifying a key protection certificate

(76) Inventors: Yves Louis Gabriel Audebert, Los Gatos, CA (US); Eric F. Le Saint, Fremont, CA (US)

Correspondence Address: STEVENS, DAVIS, MILLER & MOSHER, LLP, Suite 850, 1615 L Street, N.W., Washington, DC, 20036, US

(21) Appl. No.: 09/892,904

(22) Filed: Jun. 28, 2001

(51) Int. Cl. G06F 12/14

(52) U.S. Cl. 713/193; 380/30

(57) ABSTRACT

A data processing method and system for generating and verifying a key protection certificate.

The data processing system comprises a PSD including a unique device name, cryptography means, data processing means, data storage means and communications means.

The cryptography means includes an asymmetric key pair generating algorithm, a first securely shared secret key, a second securely shared secret key, symmetric cryptography means, a concatenation algorithm, a message authentication code algorithm, cryptographic seed information, a key protection certificate algorithm and a signing algorithm.

### FIELD OF INVENTION

The present invention relates to a data processing system and method for generating a unique digital certificate within the secure domain of a personal security device (PSD). The generated certificate is used by another party to verify that cryptographic keys are bound to and protected by a specific PSD.

### BACKGROUND OF INVENTION

The current art involving personal security devices (PSD) including smart cards, subscriber identification modules (SIM), wireless identification modules (WIM), identification tokens and related devices are designed to afford enhanced protection of asymmetric private keys and shared secret symmetric keys over that provided by software solutions or other means.

PSDs also provide improved support of digital signature applications for non-repudiation purposes than is afforded using software solutions or other means. For non-repudiation purposes, it is essential that private and secret keys be protected by the security mechanisms implemented within a PSD and not be disclosed. This is a basic foundational premise behind the various public key infrastructures available in the current art and as such is an area vulnerable to compromise by a sophisticated attacker as described below.

Currently, there are two methods in which cryptographic keys are installed within the secure domains of a PSD. The first method involves placement of cryptographic seed information inside a PSD which is then used to generate cryptographic keys based upon internal key generating algorithms. A second method involves directly injecting the cryptographic keys into a secure domain of the PSD and storing the keys in accordance with the security policies included in the PSD.

Neither method generates any proof to another party that the cryptography keys are securely stored and bound to the PSED in which they were intended. The keys exist essentially independent of the device in which they are stored. Users and third parties therefore implicitly rely upon the security of the installation process to ensure that the cryptographic keys have been installed in the correct PSD and have not been replaced or duplicated in another unauthorized device.

Until recently, the generation of cryptography keys in PSDs occurred using end-to-end security mechanisms. The card issuer controlled all aspects of key generation and card issuance, which provided little opportunity for unauthorized disclosure of private or secret keys. However, as demand for increased security mechanisms and storage of multiple credentials on a single card has developed, the use of end-to-end security mechanisms is being replaced with remote post issuance methods,

For example, U.S. Pat. No. 6,005,942 describes a post issuance method of installing applications into a smart card. This method allows an authorized entity other than the original card issuer to install applications including proprietary information such as cryptographic seeds, private keys and symmetric keys into a secure domain of the card.

The implicit assumption utilizing this method is that the existing cryptographic keys employed during the post issuance installation process have not been compromised. Thus, it becomes possible for an authorized provider, unaware that the original cryptographic keys have been compromised to operatively install additional proprietary information into an unauthorized card There currently is no method for verifying that a particular key is bound to a particular device.

### SUMMARY OF INVENTION

This invention provides a method for generating a unique key protection certificate, which provides assurances to another party that private or secret (symmetric) keys are securely stored within the PSD. The certificate is generated using the cryptographic services and data processing capabilities normally provided with the current generation of PSDs.

A typical PSD, for example a smart card, contains a microprocessor for executing programmatic instructions, read only memory (ROM) for containing essential programs such as a runtime environment and security policies, non-volatile memory for storage of Information using electrically erasable programmable read-only memory (EEPROM) and lastly volatile random access memory (RAM) for temporary storage of information.

The installed security policies and added security extensions generally support standardized cryptographic methods including asymmetric key methods such as DSA, RSA, or both, symmetric key methods such as DES, 3DES or both, non-keyed message digest methods such as MD5, SHA-1 or both and keyed message digest methods such as MAC.

PSDs are also configurable to allow separate secure domains allowing different providers to store proprietary information including symmetric and asymmetric keys. Each domain allows access to common utilities and services installed in the PSD but the PSD's security policies prevent accessing of secure information installed outside of a providers allocated domain. Thus, multiple sets of separately accessible keys may exist within a PSD at any one time but only the owner of the keys may access the domain in which they are installed.

By using the established security policies and added extensions employed in a typical PSD, it is possible to generate a key protection certificate, which provides greater assurances to another party that private or secret keys are bound to and protected by a PSD.

To practice this invention, a key protection certificate generating algorithm is loaded into a common domain of a PSD and operatively stored in either the system ROM during masking or in non-volatile RAM. This algorithm operates sequentially with installed cryptographic key generating algorithms and a pre-encoded device name (usually the PSD's serial number) to produce a unique digital certificate upon completion of cryptographic key generation. The digital certificate is then available for verification.

In the preferred embodiment of the invention, an additional set of parameters is generated which includes contextual attributes related to the PSD and a particular private or symmetric key generated within the PSD. The contextual attributes may include but are not limited to a counter, trusted time source, the date and time of generation, version numbers, applications the key is intended to be used for, key life cycle information (expiration date, etc.), cryptography methods employed, key identification labels and receiving party identification information.

A portion of the contextual attributes are intended to be available as clear text in the key protection certificate along with the device name for review and verification by a receiving party. The remaining portion of the contextual attributes are obfuscated using a second symmetric encryption method and key. Some or all of these attributes may also be used to reference or diversify the shared secret keys by the receiving party. The receiving party may be a second party who is seeking direct verification of the sending party's credentials using for example pretty good privacy (PGP) techniques or a trusted third party certificate authority (CA) who provides the verification as part of an organized service using for example X.509 formatted certificates. For simplicity, “receiving party” will be used to refer to both a second party and trusted third party.

In the preferred embodiment of the invention, the key protection certificate is produced by encrypting a portion of the contextual attributes with a first shared secret key, signing a device name (or derivation thereof) with a private key and concatenating the encrypted portion of the contextual attributes, clear text portion of the contextual attributes, clear text device name and signed device name producing an intermediate result. This intermediate result will be used by a receiving party to verify that the private key is securely stored in the PSD. Additionally, the intermediate result may be used to prove that the result was generated within the secure domain of the PSD.

A message authentication code (MAC) function is then performed on the intermediate result and encrypted using a second shared secret key. The second shared secret key is a symmetric key known only to the PSD and the receiving party. The results of the MAC are then concatenated with the intermediate result described above, producing the key protection certificate. The MAC portion will be used by a receiving party to verify that the device private key was generated within the secure domain of the PSD. Once produced, the certificate is available for verification by a receiving party.

A receiving party verifies the certificate by cross referencing the device name (or derivation thereof) with the proper public contextual information, secret keys, public key, cryptographic algorithms, reference parameters, etc. contained in a database, lookup table or similar arrangement. Once the proper access information is determined, the verification is performed by decrypting the device name portion of the certificate using the complementary public key and comparing the result to the plain text version of the device name This operation confirms to the receiving party that the transaction occurred using the proper key pair.

Next, the receiving party, using the same MAC algorithm and shared secret key generates a duplicate MAC. The generated MAC is then compared to the MAC contained in the certificate. An exact match between the independently created MAC and the received MAC provides assurances that the transaction occurred within the secure domain of the PSD.

Lastly, the private contextual attributes are decrypted using a second shared secret key and compared to reference parameters securely shared between the PSD and the receiving party. An exact match of these parameters provides further assurances that the certificate was validly generated. The parameters maintained by the receiving party may be a counter which increments each time the certificate is verified, a trusted time stamp or another variable controlled by the receiving party which is securely shared with the PSD.

New digital certificates may be generated each time an authorized change is made to any of the cryptography algorithms or keys contained within the PSD. In the preferred embodiment, context attributes are updated and stored as part of the digital certificates.

It should be understood to those familiar with the art that more than one digital certificate and associated cryptography keys might be stored within the secure domain of a PSD for servicing different receiving parties. The number of digital certificates and associated cryptography keys is limited only by available memory resources. In the preferred embodiment of the invention, the key protection certificate is intended to conform to the X.509 and/or ANSI X.9 certificate format standards for use by a trusted third party certificate authority.

Furthermore, different combinations of asymmetric and symmetric keys, signed and unsigned message digest functions, and other information may be employed to generate and validate an equivalent key protection certificate. For example, a null vector could be signed with the private key rather than using the device name. Other combinations involving the use of shared secret keys and a private key will work as well

### BRIEF DESCRIPTION OF DRAWINGS

FIG. 1—is a general system block diagram for implementing present invention.

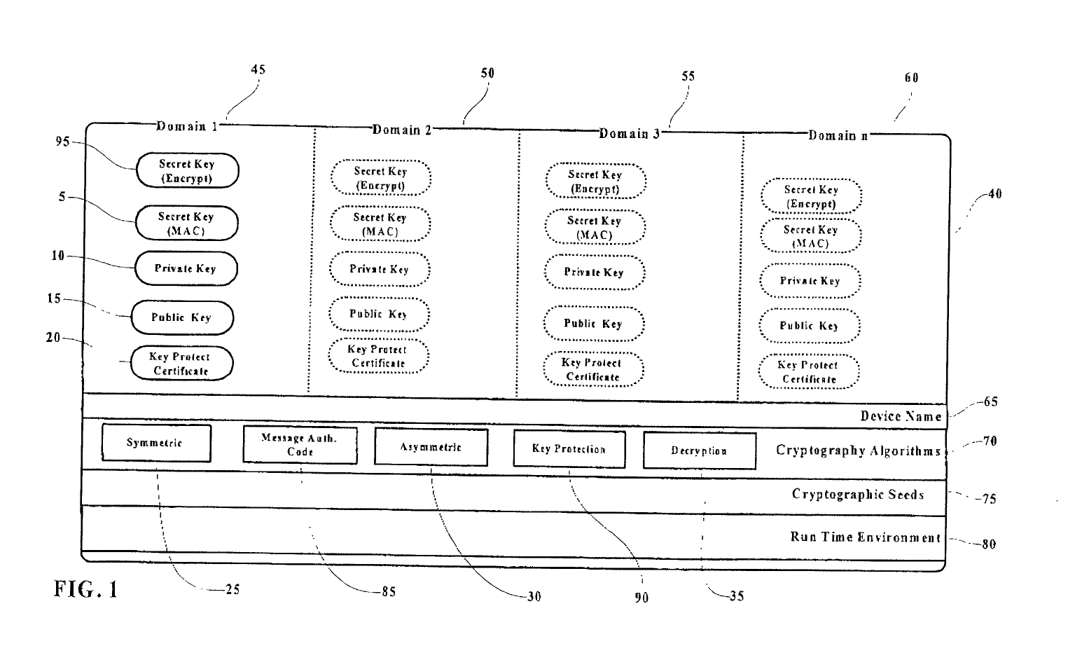

FIG. 2—is a detailed block diagram illustrating the digital certificate generating process.

FIG. 3A—is a detailed block diagram illustrating the first part of the validation process.

FIG. 3B—is a detailed block diagram illustrating the second part of the validation process.

FIG. 3C—is a detailed block diagram illustrating the third part of the validation process.

FIG. 4—is a detailed block diagram illustrating final part of the validation process.

### DETAILED DESCRIPTION OF PREFERRED EMBODIMENT

In this invention, a key protection certificate is created and stored sequentially in conjunction with cryptographic key generation. In the preferred embodiment of the invention, a shared secret key is securely injected into a PSD during or after personalization. In one embodiment of the invention, the secret key is shared with a second party who will perform the direct verification of the digital certificate when received. In another embodiment of the invention, the secret key is shared with a trusted third party certificate authority who performs the verification of the certificate and informs a third party of the validly of the certificate in the form of an X.509 and/or ANSI X.9 formatted certificate.

Referring to FIG, 1, a typical arrangement of a PSD 40 is depicted where separate domains (Domain 1 45, Domain 2 50, Domain 3 55 through Domain n 60) are established allowing unrelated service providers to install and maintain provider specific sets of asymmetric public 15 and private keys 10, a first shared secret key (MAC) 5 used during the encryption of the message digest, a second shared secret key (Encrypt) 95 used for encrypting the private portion of the contextual attributes, and key protection certificate 20.

A unique device name 65 is generated during the PSD manufacturing process, which is common and accessible to all domains but unalterable for the life of the PSD. Cryptographic algorithms 70, including symmetric 25 and asymmetric 30 key generating modules, a message authentication code module 85, the added key protection certificate module 90 and asymmetric decryption module are contained in an API layer and are likewise common and accessible to all domains. These modules are used for generating the cryptographic information stored in each of the providers secure domain. Another layer 75 contains cryptographic seed information for generation of cryptographic keys.

PSDs follow a layered structure in which an applications programming interface (API) rides above a runtime-operating environment 80. In the preferred embodiment of the invention, the layers below the API layer are unmodified and thus not included in the basic depiction.

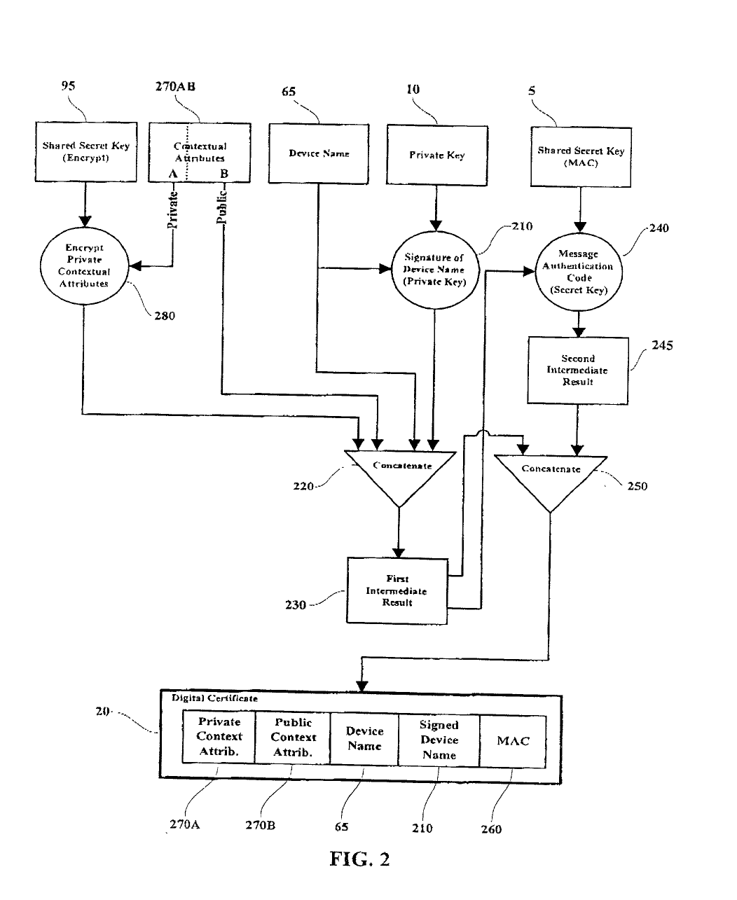

In FIG. 2, a detailed block diagram of the digital certificate generating process is depicted. To generate the key protection certificate 20, an initial set of contextual attributes is generated 270AB. A portion of the initial contextual attributes are then encrypted with a first shared secret key 95 forming a private and public set of contextual attributes, followed by signing the device name 65 with a private key 10. The device name may be the PSD serial number or name derived from the serial number. The signed device name 210 is then concatenated 220 with the clear text device name 65, public contextual attributes 270B and private contextual attributes 270A to produce a first intermediate result 230.

The first intermediate result 230 is then processed using a message authentication code 240 and a second shared secret symmetric key 5 producing a second intermediate result 245. The second intermediate result 245 is then concatenated 250 with the first intermediate result 230 producing the key protection certificate 20. Once generated, the certificate is available for validation by a receiving party.

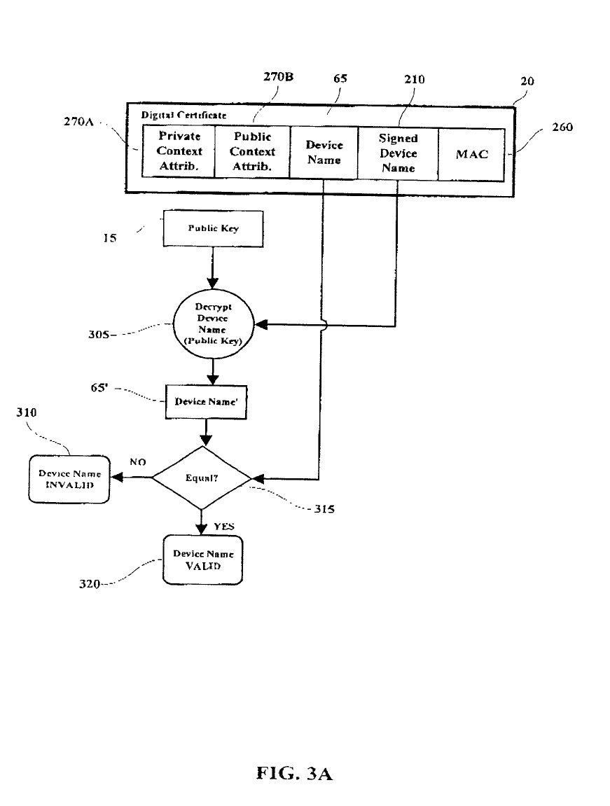

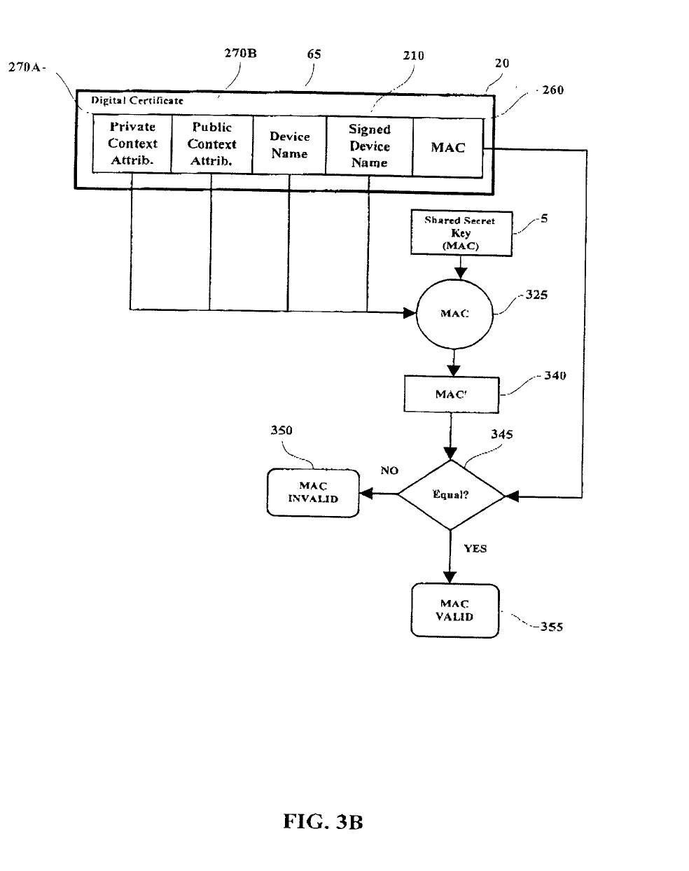

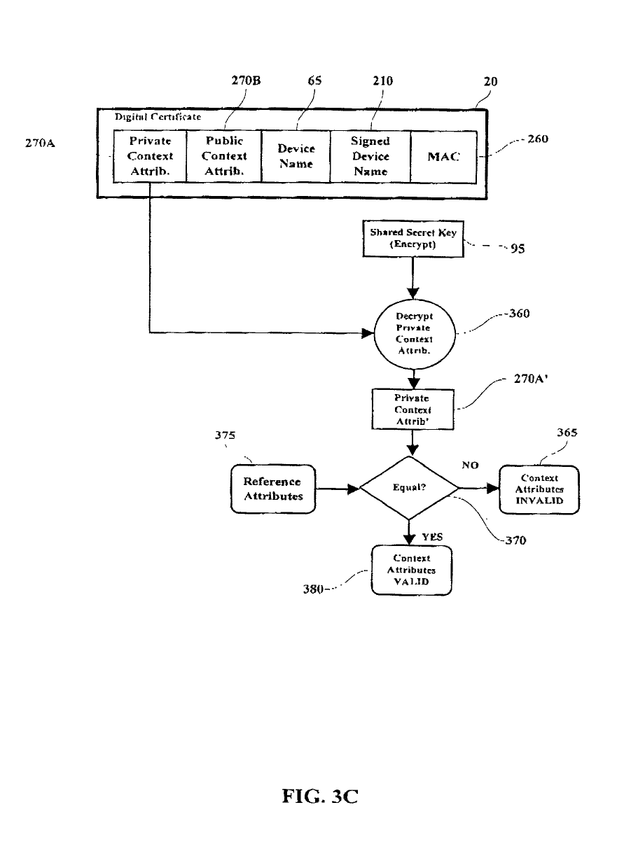

In FIG. 3A, a detailed block diagram of the first part of the multi-step process employed to validate the key protection certificate 20 is depicted. Upon receiving the key protection certificate 20, the portions of the digital certificate containing the plain text device name 65 and signed device name 210 are extracted. The device name 65 is used to cross-reference the required cryptographic keys, algorithms and reference parameters necessary to perform the validation process.

Once the proper access information has been determined, the signed device name 210 is decrypted 305 using the complementary public key 15 resulting in an unverified device name 65′. The unverified device name 65′ is compared 315 to the extracted device name 65. If the results are equal 320, then the private key has been validated. Otherwise 310, the private key has somehow been altered and a failure flag is set in the certificate identifying the invalid key pair validation step.

Referring to FIG. 3B, the next part of the validation process generates an independent message authentication code (MAC) using a method authentication code 325 identical to that 85 implemented in the PSD. The MAC uses the portions of the certificate containing the private contextual attributes 270A, public contextual attributes 270B, device name 65, signed device name 210 and the second shared secret key 5. The resulting message authentication code 340 is compared 345 with the message authentication code 260 contained in the certificate 20. If the results are equal 355, then the key generation process can be assumed to have occurred within the secure domain of the PSD (since only the PSD and the receiving party should possess the shared secret key,) and this portion of the key generating process is validated. Otherwise 350, the key generating process may not have occurred within the secure domain of the PSD and a failure flag is set in the key protection certificate identifying the invalid key generation location step

Referring to FIG. 3C, the third part of the validation process decrypts 360 the private contextual attributes 270A using the first shared secret key 95 resulting in a clear text version of the private contextual attributes 270A′. One or more parameters included in the private contextual attributes 270A′ is compared 370 against reference parameters 375 maintained by the receiving party. If the results are equal 380, then the contextual attributes have been validated. Otherwise 365, the key protection certificate may not be valid and a failure flag is set in the key protection certificate identifying the invalid contextual attribute step.

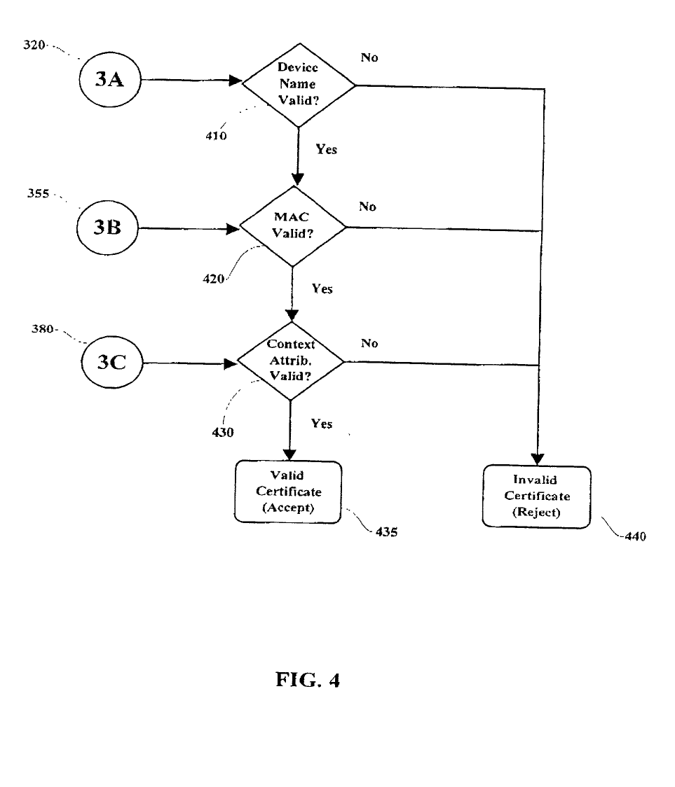

Referring to FIG. 4, the results of the preceding validation processes are summarized. If a valid device name has been verified 410 as described in FIG. 3A 320, then it is verified that a valid MAC has been obtained as described in FIG. 3B 355. If a valid MAC has been verified 420, then it is verified that valid contextual attributes have been verified as described in FIG. 3C 380. If valid contextual attributes have been verified 430, then the key protection certificate 435 is fully validated and should be accepted by the receiving party. If validation is being performed by a trusted third party certificate authority, no failure flags should be set and the validated digital certificate should be forwarded to the receiving party for acceptance.

If any of the three validation steps fail, then the key protection certificate should be rejected 440 by the receiving party. If validation is being performed by a trusted third party certificate authority, appropriate failure flags should be set and the failed digital certificate should be forwarded to the receiving party for rejection.

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks, Other variations and embodiments are possible in light of above teachings, and it is not intended that this Detailed Description limit the scope of invention, but rather by the Claims following herein

What is claimed:

1. A data processing system for generating a key protection certificate comprising;
a PSD further comprising a unique device name, cryptography means, data processing means, data storage means and communications means;
wherein said cryptography means includes an asymmetric key pair generating algorithm, a first securely shared secret key, a second securely shared secret key, symmetric cryptography means, a concatenation algorithm, a message authentication code algorithm, cryptographic seed information, a key protection certificate algorithm and a signing algorithm.

2. The system according to claim 1, wherein at least a portion of said cryptographic seed information is used by said asymmetric key pair generating algorithm to generate at least one asymmetric private key and one asymmetric public key upon receipt of at least one key generation command, said keys being stored in a secure domain.

3. The system according to claim 2, wherein said key protection certificate algorithm, upon receipt of said key generation command, generates a plurality of contextual attributes.

4. The system according to claim 3, wherein at least a portion of said contextual attributes are encrypted using said first shared secret key and said symmetric cryptography means to generate private contextual attributes.

5. The system according to claim 4, wherein the remaining unencrypted of said plurality of said contextual attributes forms public contextual attributes.

6. The system according to claim 5, wherein a signed device name is generated using said unique device name and said asymmetric private key as inputs into said signing algorithm

7. The system according to claim 6, wherein said private contextual attributes, public contextual attributes, signed device name and unique device name are concatenated by said concatenation algorithm, generating a first intermediate result.

8. The system according to claim 7, wherein a message authentication code is generated using said second shared secret key and said first intermediate result as inputs into said message authentication code algorithm, forming a second intermediate result.

9. The system according to claim 8, wherein said first intermediate result and said second intermediate result are concatenated by said concatenation algorithm forming said key protection certificate then stored in said secure domain.

10. The system according to claim 1, wherein said unique device name is an embedded serial number.

11. The system according to claim 10, wherein said unique device name is the result of a cryptographic process using said embedded serial number as a cryptographic seed.

12. The system according to claim 1, wherein said communications means includes means for receiving commands to generate asymmetric and symmetric keys and means for sending said public key and said key protection certificate.

13. A data processing system for validating a key protection certificate comprising;
data processing means, data storage means, communications means, cryptography means, a first securely shared secret symmetric key, a second securely shared secret symmetric key and a public key, wherein the cryptography means includes a message authentication code algorithm, cross referencing means and a comparator algorithm.

14. The system according to claim 13, wherein said first symmetric key, said second symmetric key and said public key have a direct generation relationship with said key protection certificate

15. The system according to claim 13, wherein said communications means includes means for transmitting requests for said key protection certificate and said public key and means for receiving said key protection certificate and said public key.

16. The system according to claim 15, wherein said received key protection certificate includes private contextual attributes, public contextual attributes, a device name, a signed device name and a message authentication code.

17. The system according to claim 16, wherein said device name is used by said cross referencing means for selecting the proper shared secret keys, public key, cryptographic algorithms and reference parameters associated with said key protection certificate.

18. The system according to claim 17, wherein said signed device name is decrypted using said public key, generating a second device name.

19. The system according to claim 18, wherein said second device name and said device name contained in said certificate are compared by the comparator algorithm to determine if said second device name and said device name contained in said certificate match.

20. The system according to claim 16, wherein a second message authentication code is generated using said private contextual attributes, public contextual attributes, device name, said signed device name included in said certificate and said second shared secret key as inputs into said message authentication code algorithm.

21. The system according to claim 20, wherein said second message authentication code and said message authentication code contained in said certificate are compared using said comparator algorithm to determine if said second message authentication code and said message authentication code contained in said certificate match.

22. The system according to claim 16, wherein said private contextual attributes are decrypted using said first shared secret key.

23. The system according to claim 22, wherein at least one predetermined parameter is contained in at least a portion of said decrypted private contextual attributes.

24. The system according to claim 23, wherein at least one predetermined parameter and said reference parameters are compared using said comparator algorithm to determine if said at least one predetermined parameter and said reference parameters match.

25. The system according to claim 19, 21 or 24, wherein a failure to achieve a match invalidates said key protection certificate.

26. A method for generating a key protection certificate comprising:
injecting a first securely shared secret symmetric key, a second securely shared secret symmetric key, a key protection algorithm and cryptographic seed information into a PSD, wherein at least a portion of said seed information is used in generating at least one public key and one private key,
storing said injected symmetric keys and said seed information in a secure domain within said PSD,
sending a command to said PSD for generating said at least one public key and one private key, wherein said command initiates generation of said keys and of said key protection certificate,
generating said at least one public key and said one private key using at least a portion of said seed information,
generating contextual attributes specific to at least the generation of said private key,
encrypting at least a portion of said contextual attributes using said first shared secret key, forming private contextual attributes and public contextual attributes,
wherein predetermined parameters are included in said private contextual attributes,
storing said public key and said private key in said secure domain,
generating a digital signature of a unique device name using said private key,
concatenating said device name, private contextual attributes, public contextual attributes with said digital signature and generating a first intermediate result,
generating a message authentication code of said first intermediate result using said second shared secret key producing a second intermediate result,
concatenating said first intermediate result with said second intermediate result producing said key protection certificate; and
storing said key protection certificate in said secure domain.

27. A method for validating a key protection certificate comprising:
receiving said key protection certificate and a public key, wherein said certificate contains at least a plain text device name portion, a signed device name portion and cryptogram portion,
cross-referencing said device name with proper shared secret keys, public key, cryptographic algorithms and reference parameters associated with said key protection certificate,
verifying said signed device name portion of said certificate using said public key, comparing the resulting device name with said device name portion included in said certificate,
independently performing a message authentication code function on said concatenated private contextual attributes, public contextual attributes, device name, and signed device name portions of said certificate using a first of said shared secret keys,
comparing the resulting message authentication code with a method authentication code included in said certificate,
decrypting said private contextual attributes using a second of said shared secret keys,
comparing at least a portion of the private contextual attributes to the reference parameters,
validating said certificate if said resulting device name matches said device name contained in said certificate, said independently generated message authentication code matches said message authentication code contained in said certificate and at least a portion of said private contextual attributes matches said reference parameter,
rejecting said certificate if any of said matches is not achieved.

28. The method according to claim 27, wherein said receiving party possesses said securely shared secret keys and said public key.

29. The method according to claim 28, wherein said receiving party is a trusted third party certificate authority.
